(19) United States
(12) Patent Application Publication
(10) Pub. No.: US 2018/0247092 A1
(43) Pub. Date: Aug. 30, 2018

(54) RFID CHECKOUT STATION USING VIRTUAL SHIELDING

(71) Applicant: NEC Laboratories America, Inc., Princeton, NJ (US)

(72) Inventors: Mohammad Khojastepour, Lawrenceville, NJ (US); Mustafa Arslan, Princeton, NJ (US); Sampath Rangarajan, Bridgewater, NJ (US)

(21) Appl. No.: 15/903,857

(22) Filed: Feb. 23, 2018

Related U.S. Application Data
(60) Provisional application No. 62/463,776, filed on Feb. 27, 2017.

(51) Int. Cl. G06K 7/10; G07G 1/00; G01S 11/06

(52) U.S. Cl. CPC G06K 7/10079; G01S 11/06; G06K 7/10069; G07G 1/009

(57) ABSTRACT

A method for detecting RFID tags attached to items positioned at a radio frequency identification (RFID) self-service checkout station is presented. The method includes creating one or more virtual shields at the RFID self-service checkout station, the one or more virtual shields defining checkout bins, associating RFID readers to the checkout bins, and enabling an RFID reader associated with the checkout bins to differentiate between RFID tags attached to items positioned inside a checkout bin and RFID tags attached to items positioned outside the checkout bin by at least determining a signal strength of each RFID tag detected by the RFID reader and estimating, based on an outcome of the signal strength of each RFID tag, a distance between each RFID reader and each RFID tag.

### RELATED APPLICATION INFORMATION

This application claims priority to Provisional Application No. 62/463,776, filed on Feb. 27, 2017, incorporated herein by reference in its entirety.

### BACKGROUND

### Technical Field

The present invention relates to checkout stations and, more particularly, to radio frequency identification (RFID) checkout stations using virtual shielding.

### Description of the Related Art

Self-checkout point of sale (POS) systems are well known. One example of such a system is found in grocery stores having self-checkout lanes. A POS typically includes a terminal, bar code reader, a computer, and POS software. The patron scans products using a bar code reader. The computer communicates with the patron via the POS software when the bar code reader has been successfully used to read the Universal Product Code (UPC) and then transmits the UPC information to a host server, which processes the UPC information by comparing it to a database. The database typically includes information such as number of units in stock, price per unit, and any other information which may facilitate the transaction in addition to the UPC.

### SUMMARY

A method for detecting RFID tags attached to items positioned at a radio frequency identification (RFID) self-service checkout station is presented. The method includes creating one or more virtual shields at the RFID self-service checkout station, the one or more virtual shields defining checkout bins, associating RFID readers to the checkout bins, and enabling an RFID reader associated with the checkout bins to differentiate between RFID tags attached to items positioned inside a checkout bin and RFID tags attached to items positioned outside the checkout bin by at least determining a signal strength of each RFID tag detected by the RFID reader and estimating, based on an outcome of the signal strength of each RFID tag, a distance between each RFID reader and each RFID tag.

A method for detecting RFID tags attached to items positioned at a radio frequency identification (RFID) self-service checkout station is presented. The method includes classifying the RFID tags based on their location with respect to a checkout region by at least determining a signal strength of each RFID tag and estimating a distance between each RFID tag and an RFID reader and determining the distance between the RFID tag and the RFID reader by employing phase differences between signals transmitted by the RFID reader and modulated backscattered signals received from the RFID tag.

A radio frequency identification (RFID) self-service checkout station for detecting RFID tags attached to items is also presented. The RFID self-service checkout station includes one or more virtual shields defining checkout bins and RFID readers associated with the checkout bins, wherein an RFID reader associated with the checkout bins is configured to differentiate between RFID tags attached to items positioned inside a checkout bin and RFID tags attached to items positioned outside the checkout bin by at least determining a signal strength of each RFID tag detected by the RFID reader and estimating, based on an outcome of the signal strength of each RFID tag, a distance between each RFID reader and each RFID tag.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating RFID tags enclosed within a virtual shield and communicating with RFID readers, in accordance with embodiments of the present invention;

FIG. 2 is a block/flow diagram illustrating a radio frequency identification (RFID) reader communicating with an RFID tag, in accordance with embodiments of the present invention;

FIG. 3 is a block/flow diagram illustrating distance estimation between one or more RFID tags and one or more RFID readers, in accordance with embodiments of the present invention;

FIG. 4 is a block/flow diagram illustrating a self-service checkout station including a plurality of virtual shields defining checkout bins, in accordance with embodiments of the present invention;

FIG. 5 is a block/flow diagram illustrating a self-service checkout station including a plurality of virtual shields defining checkout bins each having a lid, in accordance with embodiments of the present invention;

FIG. 6 is a block/flow diagram illustrating a self-service checkout station including a checkout passage, in accordance with embodiments of the present invention;

FIG. 7 is a block/flow diagram illustrating a method for detecting RFID tags attached to items positioned at a radio frequency identification (RFID) self-service checkout station, in accordance with embodiments of the present invention; and

FIG. 8 is an exemplary processing system for employing a self-service checkout station including a virtual shield defining a checkout bin or a checkout passage, in accordance with embodiments of the present invention.

### DETAILED DESCRIPTION OF PREFERRED EMBODIMENTS

In the exemplary embodiments of the present invention, methods and devices for implementing radio frequency identification (RFID) technology at self-service checkout stations is introduced. Systems are disclosed that in various embodiments include devices, methods, and/or software for reading RFID tags located in defined spatial locations within the self-service checkout stations. The RFID-enabled self-service checkout stations can include spatial locations, such as virtual shields defining checkout bins and virtual checkout passages.

In the exemplary embodiments of the present invention, a method for retail item tracking is introduced. Retail item tracking can be implemented by placing an RFID tag on each retail item. An RFID reading device can transmit information to a passive RFID tag by modulating an RF signal. The RFID tag can respond by modulating the reflection coefficient of its antenna, thus backscattering an information signal to the RFID reading device. Thus, the RFID reading device can read and/or modify memory of RFID tags. Each RFID tag can store the tag identifier in its memory. An RFID tag attached to a retail item can further store in its memory a product code of the item (e.g., an EPC code) of the item and/or at least one alphanumeric string identifying the item. RFID tags can be employed in retail facilities to prevent stock “shrinkage” due to unauthorized removal of retail items which have not been properly purchased.

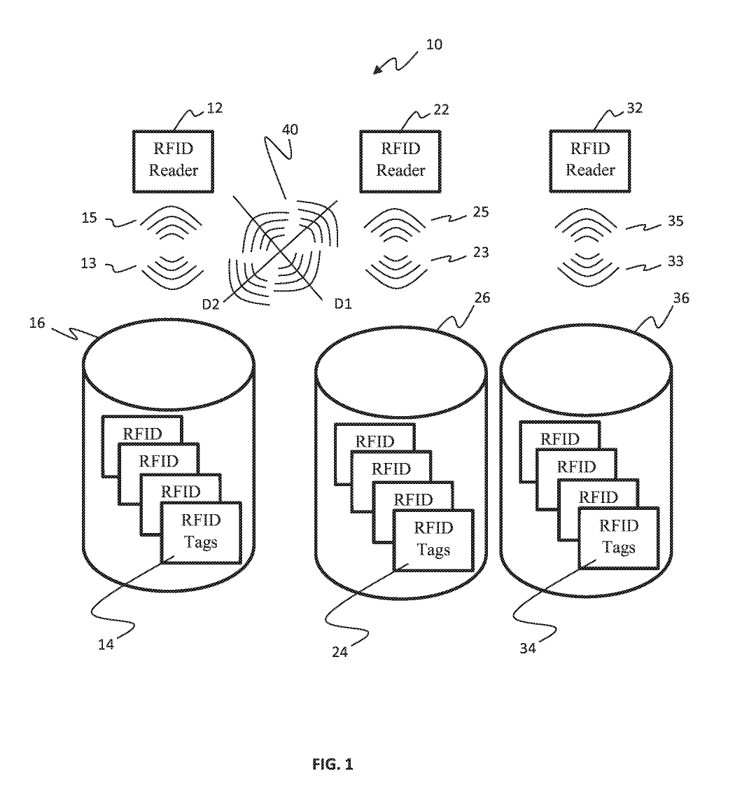

FIG. 1 is a block/flow diagram illustrating RFID tags enclosed within a virtual shield and communicating with RFID readers, in accordance with embodiments of the present invention.

The RFID system 10 includes a first RFID reader 12 in alignment with a plurality of RFID tags 14. The plurality of RFID tags 14 are confined or enclosed within a virtual shield 16. The virtual shield 16 can take on any shape or size. The RFID reader 12 can communicate with the RFID tags 14. The RFID reader 12 can transmit a signal 13 toward the RFID tags 14. In response the RFID tags 14 can send a backpropagation signal 15 to the RFID reader 12.

The RFID system 10 includes a second RFID reader 22 in alignment with a plurality of RFID tags 24. The plurality of RFID tags 24 are confined or enclosed within a virtual shield 26. The virtual shield 26 can take on any shape or size. The RFID reader 22 can communicate with the RFID tags 24. The RFID reader 22 can transmit a signal 23 toward the RFID tags 24. In response the RFID tags 24 can send a backpropagation signal 25 to the RFID reader 22.

The RFID system 10 includes a third RFID reader 32 in alignment with a plurality of RFID tags 34. The plurality of RFID tags 34 are confined or enclosed within a virtual shield 36. The virtual shield 36 can take on any shape or size. The RFID reader 32 can communicate with the RFID tags 34. The RFID reader 32 can transmit a signal 33 toward the RFID tags 34. In response the RFID tags 34 can send a backpropagation signal 35 to the RFID reader 32.

The first RFID reader 12 is configured to read only the RFID tags 14 that are within the boundaries set by the virtual shield 16. Thus, the first RFID reader 12 cannot read the RFID tags 24 and the RFID tags 34. The first RFID reader 12 can differentiate between the RFID tags 14 and the RFID tags 24, 34 based on at least two parameters. First, the RFID reader 12 can determine a signal strength of the RFID tags 14, 24, 34. Because of the proximity of the first RFID tags 14 to the first RFID reader 12, the signal strength is relatively high. Similarly, because of the proximity of the second and third RFID tags 24, 34 to the first RFID reader 12, the signal strength is relatively low. Therefore, the RFID reader 12 can make a determination, based on signal strength, which of the RFID tags 14, 24, 34 are within the first virtual shield 16. Stated differently, if the signal strength exceeds or is above a first predetermined threshold value, then the RFID reader 12 can read the first RFID tags 14. If the signal strength is below a second predetermined value, then the RFID reader 12 does not read the third RFID tags 34. However, if the signal strength is between the first and second threshold values, then the RFID reader 12 can consult another factor in making a determination as to whether or not to read the second RFID tags 24. For example, a distance measurement can take place.

In one example, a distance D1 can be determined between the first RFID reader 12 and the second RFID tags 24. If the distance D1 exceeds a threshold, then the RFID reader 12 can determine that the big distance between itself and the second RFID tags 24 indicates that the second RFID tags should not be read. In fact, the RFID tags 24 should be read only by the second RFID reader 22 because the distance between the second RFID reader 22 and the second RFID tags 24 is below a predetermined threshold value. Similarly, the second RFID reader 22 does not read the first RFID tags 14 because the distance D2 between the second RFID reader 22 and the first RFID tags 14 exceeds the predetermined threshold value. The communications 40 can thus be prohibited.

Therefore, virtual shields 16, 26, 36 are created in the vicinity of a self-service checkout area or region. The RFID readers 12, 22, 32 have the capability to differentiate or distinguish between RFID tags 14, 24, 34 located or positioned inside virtual shields 16, 26, 36 defining checkout bins and RFID tags 14, 24, 34 located or positioned outside virtual shields 16, 26, 36 defining checkout bins. A combination of distance measurements between readers 12, 22, 32 and RFID tags 14, 24, 34 is employed and RFID tag 14, 24, 34 signal strength measurements.

RFID tags can enhance the checkout process and make it even more customer friendly. First, since RFID tags are read wirelessly, there is no need to locate the tag and manually align it with the scanner as it is the case with the barcodes. Second, it is possible to scan multiple items at the same time by placing them on or in to the checkout station at once. Of course, this simultaneous reading is from the perception of human eye as the need for manual scanning of items is removed. However, the underlying wireless communication with the tags occurs serially in a very short amount of time (say a fraction of a second). Third, RFID tags reduce the possibility of human error since the tags in the vicinity of the checkout station (or checkout bin) are read directly without a person presenting the tag to a reader that is the case in barcode systems. Hence, it is not possible to present a different (wrong) barcode, not scan the barcode, or scan a barcode twice or more in error. Fourth, RFID tags can mark each item with a unique ID (as opposed to a common ID used for the same item type in barcodes). Hence, it is easier to know exactly which item is sold and adjust the price of a similar item differently than others, e.g., for a distressed or open-box merchandise. All mentioned benefits of using RFID in the checkout process manifest itself in both self-checkout systems and regular checkout counters where an attendant is present.

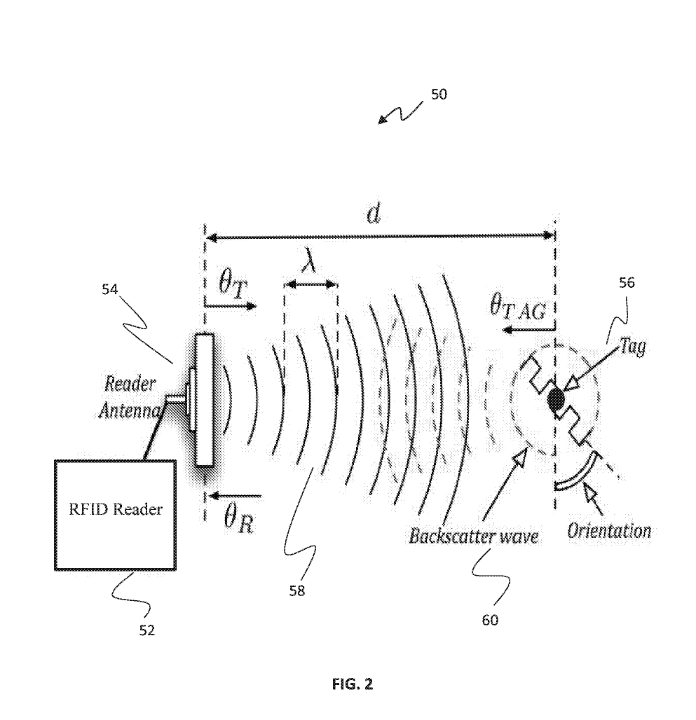

FIG. 2 is a block/flow diagram illustrating a radio frequency identification (RFID) reader communicating with an RFID tag, in accordance with embodiments of the present invention.

The system 50 depicts an RFID reader 52 having an RFID antenna 54 for communication with a RFID tag 56. The RFID reader 52 transmits a signal 58 toward the RFID tag 56. In response, a backscatter wave 60 is emitted from the RFID tag 56 toward the RFID reader 52. The distance “d” between the RFID reader 52 and the RFID tag 56 can be used as one factor in determining whether the RFID reader 52 should read the RFID tag 56. Additionally, a signal strength of signal 60 is measured in order to further determine whether the RFID reader 52 should read the RFID tag 56.

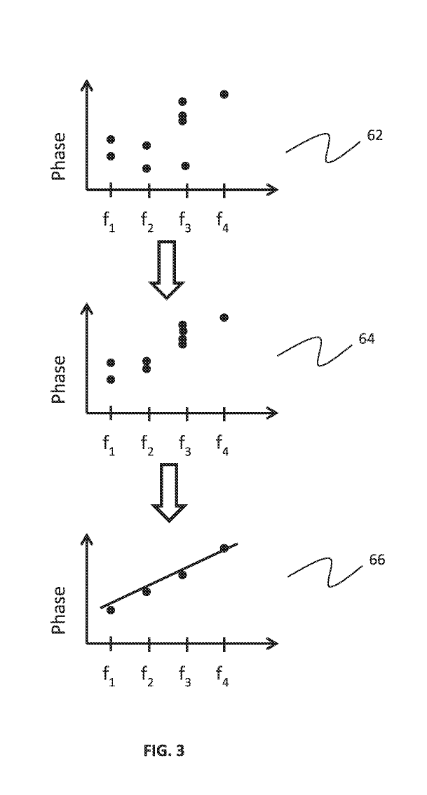

FIG. 3 is a block/flow diagram illustrating distance estimation between one or more RFID tags and one or more RFID readers, in accordance with embodiments of the present invention.

The distance estimation can be computed as follows. The signal strength can be used as a filter. If the signal strength is above a first predetermined threshold value (or is too high), then the RFID tag exhibiting such high signal strength is in the checkout bin assigned to the RFID reader in proximity to it. If the signal strength is below a second predetermined threshold value (or is too low), then the RFID tag exhibiting such low signal strength is not in the checkout bin of its closest RFID reader. If the signal strength is somewhere in between the first predetermined threshold value and second predetermined threshold value, then a distance estimation takes place because it is indeterminate is the RFID tag is inside or outside the target checkout bin.

In graph 62, the RFID reader interrogates the target RFID tag on a plurality of different frequencies. For each frequency, the tag responds (via backscatter wave) and the reader measures a phase difference between the reader transmitted signal and the tag received response. Therefore, a curve of phase differences across multiple frequencies is obtained based on a sequence of tag responses.

In graph 64, the phase curve is modified by removing measurement noise and ambiguity. This results in deriving an average phase value for a given frequency.

In graph 66, the average value at each frequency is used to compute the slope of the phase-frequency curve to estimate the distance between the RFID reader and the target RFID tag. This distance determination is used to supplement the signal strength measurements above in order to more accurately determine positioning or placement of the target RFID tag with respect to the RFID reader. Therefore, a combination of parameters or factors can be used to solidify positioning of RFID tags with respect to a plurality of RFID readers.

As a result, a combination of signal strength (or received signal strength indicator (RSSI)) and differential signal phase between transmit and receive signals is employed to identify the tags that are in the bin by generating a bounding box (or virtual shield) that virtually separates the interior from the exterior of the bounding box. The process commences by employing the tag replies and processing them to generate the differential phase shift of the signal as well as its power (e.g., RSSI) for every tag that is read. This information is stored in a particular data structure until enough samples are obtained from a tag. The samples have to satisfy certain criterion including the time lag between the samples, the operating frequency for each sample, etc. The process of finding the phase shift has an inherent ambiguity of 2 pi phase shift. However two different techniques may be used in finding the phase differential. Most hardware support particular kind of differential phase estimation that has ambiguity of pi instead of 2 pi.

To remove the ambiguity, it is necessary to consider multiple samples. In one example, RFID interrogators are employed that operate in a US frequency range of 902 MHz to 928 MHz and frequency hopping in 50 equally spaced bands is employed within this frequency range. The number of different frequency samples as well as their separations is also another factor that has to be considered before combining the samples and inferring meaningful results. For all samples that belong to the same frequency some filtering operation happens to remove the ambiguity (of either pi or 2 pi depending on the differential phase estimation hardware and software technique). The operation includes grouping the differential phases into groups of particular distances that could be considered in some form of classification. Then the groups are merged and their representative class value is obtained. This representative class value could be, for example, an arithmetic mean, weighted mean, or median. This procedure is called intra-frequency differential phase ambiguity resolution.

An output of intra-frequency phase resolution may also indicate the possibility of a nonstationary tag, e.g., when the RFID tag is moving rapidly or a metal or another radio wave reflective object is moving in vicinity of the tag. The next step is the inter-frequency phase resolution. For an RFID tag at a particular distance from the RFID reader, the reading at different frequencies should follow a particular curve. This curve is close to a straight line when the ratio of system bandwidth to a center frequency is small. However, in general, this curve is not a straight line and is a part of a hyperbola. Knowing the residing curve structure, e.g., a straight line, for all the differential phase offsets from the previous step, an algorithm further removes the ambiguities of the phases for all frequencies by fitting the proper curve into it. In general, all possible cases of phase offsets can be considered and it can be checked which fitted curve has the least error. However, some fast implementation of this step is desirable in order to speed up the process. A greedy algorithm can be employed to fit a curve by considering adjacent frequencies in a particular order.

The next step is to fit a curve to all cleaned differential phase offsets based on a fitted curve that estimates a distance of the RFID tag from the RFID reader. An algorithm considers the combination of RSSI and this distance estimation along with a history of reading from all the RFID tags in order to classify the RFID tags in the checkout bin and follow the movement of the RFID tag.

One approach involves response based tag ranging. A naive but low cost approach is to perform ranging based on the tag response. This means that the tags that respond to the reader queries are considered to be within the range or inside the bounding box and the ones that do not respond are determined to be out of the range. This approach is in theory using a single threshold for the tag response to split the space into exterior and interior regions. However, there is a considerable area for which the tag may occasionally respond or occasionally not respond. These areas are do not exactly match the definition of the edge region but can be interpreted as an edge region. A more sophisticated algorithm may take into account the frequency in which a tag responds to a query or a history of the responses in a given time interval. A function or algorithm may then determine if the tag is in the interior or exterior region.

It is noted that changing the RFID readers' power can affect a size of the bounding box and the size can be shrunk by reducing the power. However, the problem with the occasional reading or not reading of an RFID tag may still persist. Moreover, the tag response or the frequency of the responses within a time frame is also a function of other environmental factors, such as a volume or a type of merchandise to which the tag is attached. The number of the tags that are within the read range also affect the possibility of the tag responses and its frequency.

Another approach involves power based or RSSI based ranging. The power based ranging is usually very rough and in fact can vary considerably even on a straight line of sight from the reader. Generally, RSSI is reduced as the RFID tag moves away from the RFID reader. Nonetheless, when a tag is moved away from the reader, there are isolated points opposite to the trend of RSSI reduction where the signal strength increases substantially, e.g., in the orders of 10 dB or more, with respect to the points in its vicinity. This could be as a result of constructive interference or multi-path considerations. However, it is usually desirable to read the tags as fast as possible. Hence, RSSI is employed as an indicator measure with two thresholds. An RSSI above a threshold indicates that the tag is in the “interior” region and an RSSI below a threshold indicates that the tag is in the “exterior” region. However, the intermediate values of RSSI indicates an “unknown” position.

This approach in effect follows a similar concept as splitting a space into three regions: the interior, the exterior, and the edge. However, the edge in this case could be very large, e.g., it may contain points that are more than a meter away. The main challenge in picking the threshold is that the threshold that is used to indicate the interior region should be discreet enough to almost surely define points that are inside the bin. In other words, the probability of having an isolated area outside the bin for which the RSSI reading is above this threshold should be negligibly small, or zero. However, picking the other threshold that defines that the points are in the exterior region is much simpler as it is possible to probe the points in the desirable bounding box and set the threshold to be below the RSSI reading of all the probe points.

The power based ranging alone cannot precisely determine if the tag is in the interior, exterior, or edge regions. However, the RSSI or power based approach is quite fast in making a decision. Therefore, a log of RSSI values in a given interval in the past from the current time would help in more accurate classification of the RFID tag. However, the size of such time interval should be taken into consideration. A large interval can cause legacy and can affect a decision with a false alarm or misdetection by considering data that are too old. On the other hand, a short interval reduces the accuracy. One possible approach is to factor a weight for each measurement in the decision where the weight is a decreasing function by increasing a time difference from a current time (decision time) and a measurement time.

Another approach is distance based ranging. While ranging could cover the cases where the method and system can only distinguish the placement of the object on interest roughly, e.g., in one of several possible areas, distance estimation usually refers to a more precise version of the ranging where the location of the object of interest is found within the accuracy of the estimation technique. The distance based ranging is usually much more accurate than the power based ranging and it is less affected by multi-path. In particular by moving, say in a straight line, away from the reader, the distance estimate is usually a monotonic and increasing function up to the accuracy of the estimation. It should be noted that the true distance estimate is not a decisive factor in this case as the bounding box can be decided based on a threshold. Moreover, a monotone increasing function can be mapped by a function or for example a look up table to the true distance estimate. This can be viewed as a calibration process for the distance estimate. While RSSI exhibits a strange behavior and there are isolated areas where the RSSI suddenly increases, the distance measurement does not exhibit such phenomenon (of course for the values within the resolution or accuracy of the distance estimate).

Similar to RSSI based ranging, distance estimation based ranging can provide IN or OUT estimates or classification for a tag based on single or double thresholds. For example, a VALID distance estimate can be employed as an indicator measure and can be compared to two thresholds. A distance estimate larger than a threshold indicates that the tag is in the “exterior” region and a distance estimate less than a threshold indicates that the tag is in the “interior” region. This can also be performed by employing a single threshold by reporting a distance estimate larger than or smaller than a single threshold to indicate that the tag is in the “exterior” region or the “interior” region, respectively. However, in both approaches, there is a possibility that there are not enough measurements to estimate the distance, hence the distance estimate is considered MEASUREMENT-NOT POSSIBLE or simply UNKNOWN. Also, if two different thresholds are employed, the intermediate values of distance estimates that fall in between the two thresholds also indicate UNKNOWN (or NOT-INOR-OUT) position.

In addition to classifying the tag as VALID (that is either IN, OUT, or UNKNOWN (equivalently NOT-IN-OR-OUT)) or UNKNOWN (MEASUREMENT-NOT-POSSIBLE) states that is returned by the distance based classification, there is a new state that distance estimation can report. Where there are enough measurements to run the distance estimation on the data, in some cases, the data exhibit transitory values which is an indication that the tag is moving during the data gathering interval or an object in the vicinity of the reader, or the tag is moving and the environment is nonstationary. This is a feature of the distance estimation process that can determine a new state as MOVING for the tag.

The drawback of distance based ranging is the time that is required to perform distance estimation as well as the time that is required to gather enough samples to reach the desired accuracy or resolution for the distance estimation process. Hence the distance based ranging alone is not a very efficient way to determine if the tag is in the interior, exterior, or edge regions. A combination of the RSSI or power based ranging and distance based ranging not only can overcome this deficiency and speed up the process of decision making, but also can increase the precision and accuracy of the classification technique. Therefore, a log of the distance estimates similar to RSSI values in a given interval in the past from the current time can be kept in order to perform classification.

Another approach is classification based on tag response, power, and distance. As mentioned, the ranging scheme based on tag responses, received signal power to the interference ratio (power), and the distance exhibit various pros and cons. The ranging based on tag response has the lowest accuracy, fastest classification, and lowest cost, while the ranging based on power has better accuracy and it is still quite fast. The ranging based on the distance has the highest cost in terms of the time required to gather the samples and computational complexity of distance estimation algorithm which means that it is slow, however, it can be made quite accurate.

A combination of these approaches can reach an accuracy that is beyond and better than either one alone and at the same time it can improve the classification time including the time that is required to gather the sample. It all comes at a price of higher computational complexity for the algorithm. The improvement in accuracy relies on the fact that more information, e.g., not only the phase but also the RSSI and timing of each received response, is used in classification process. On the other hand, improvement of the classification speed relies on the fact that either scheme has a confidence region in which it can determine (with very high probability) if the tag is inside or outside without relying on the other schemes. Hence, a classification decision can be reached quicker for such cases.

One possible classification scheme is as follows. First, it is considered if a tag is still readable or not. It is assumed that a history of a tag is logged within a database for every tag for which a classification has been performed in the past. Also, histories beyond a given past interval are purged. If there is no new response from the tag in a given interval, then the tag is classified as EXPIRED.

If the tag is not expired, the confidence intervals are checked based on RSSI. If the RSSI is high enough, which means it is larger than a given threshold, the tag is classified to be IN. If the RSSI is low enough, which means it is smaller than a given threshold, the tag is classified to be OUT. If none of the above holds for the tag based on the power, then a distance measurement takes place. In this case, three values are logged by going through a loop from the most recent distance reports to the least recent one. The first valid distance (not UNKNOWN or MOVING) is logged, as well as the count of the number times in a given interval that a tag has been classified by the distance estimation algorithm to be IN. The count of the number times in a given interval that a tag has been classified by the distance estimation algorithm to be OUT is also logged.

If there is no IN estimate and there is at least one OUT estimate, the tag is classified to be OUT. It is also possible to use a ratio of number of IN estimates to the number of OUT estimates to perform a classification. It is also noted that if the first valid estimate is IN there is a very high probability that the tag is in fact inside the bounding box since the probability of a false alarm for the distance estimation is usually very low, although the probability of misdetection could be higher.

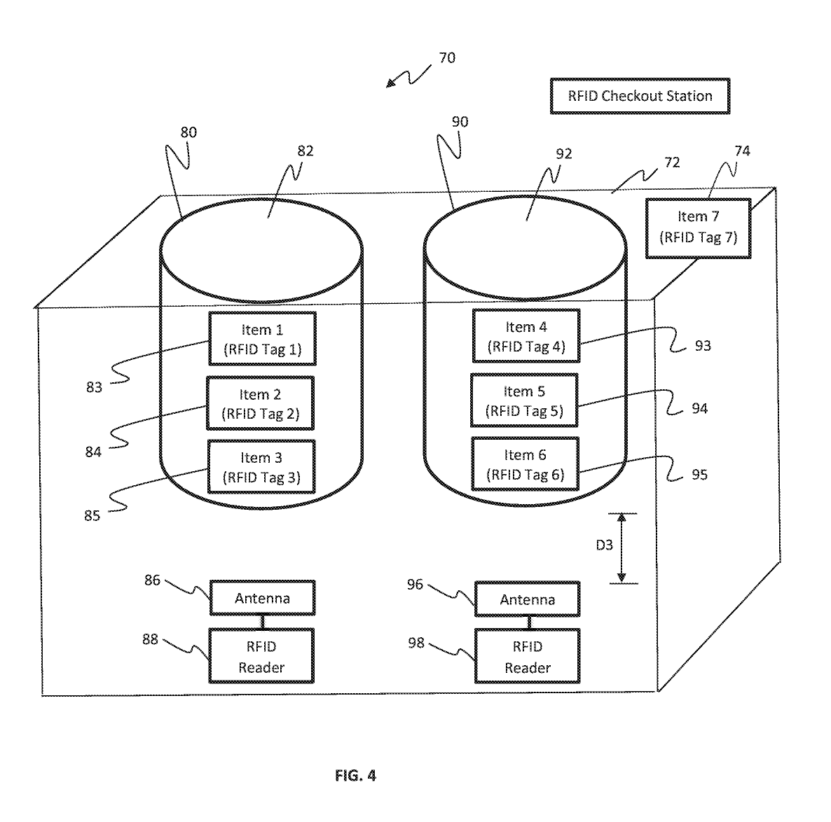

FIG. 4 is a block/flow diagram illustrating a self-service checkout station including a plurality of virtual shields defining checkout bins, in accordance with embodiments of the present invention.

The RFID self-service checkout station 70 includes a table 72 defining a first virtual shield 80 and a second virtual shield 90. The first virtual shield 80 includes an opening or recess 82 and the second virtual shield 90 includes an opening or recess 92.

The first virtual shield 80 defines a first checkout bin and the second virtual shield 90 defines a second checkout bin. The first checkout bin 80 includes, e.g., a first item having a first RFID tag 83 attached thereto, a second item having a second RFID tag 84 attached thereto, and a third item having a third RFID tag 85 attached thereto. Similarly, the second checkout bin 90 includes, e.g., a first item having a first RFID tag 93 attached thereto, a second item having a second RFID tag 94 attached thereto, and a third item having a third RFID tag 95 attached thereto. The first virtual shield 80 is associated with or assigned to a first RFID reader 88 having an antenna 86. The second virtual shield 90 is associated with or assigned to a second RFID reader 98 having an antenna 96. The first RFID reader 88 is in alignment with the virtual shield 80 and the second RFID reader 98 is in alignment with the virtual shield 90. Stated differently, the first RFID reader 88 is positioned or placed or fixed directly underneath the first virtual shield or checkout bin 80 and the second RFID reader 98 is positioned or placed or fixed directly underneath the second virtual shield or checkout bin 90. In one example, the distance D3 between the RFID readers and the virtual shields can be, e.g., 40 cm. Of course, one skilled in the art can contemplate setting the vertical distance between the RFID readers and the virtual shields to any desirable or suitable distance.

The first RFID reader 88 is configured to read only items places in the checkout bin 80 and the second RFID reader 98 is configured to read only items places in the checkout bin 90. Additionally, both RFID readers 88, 98 are configured to ignore items outside their respective associated or assigned bins. For example, RFID tag 74 cannot be read by either the first RFID reader 88 or the second RFID reader 98. Therefore, RFID tags 93, 94, 95 and RFID tag 74 are not being read by the first RFID reader 88.

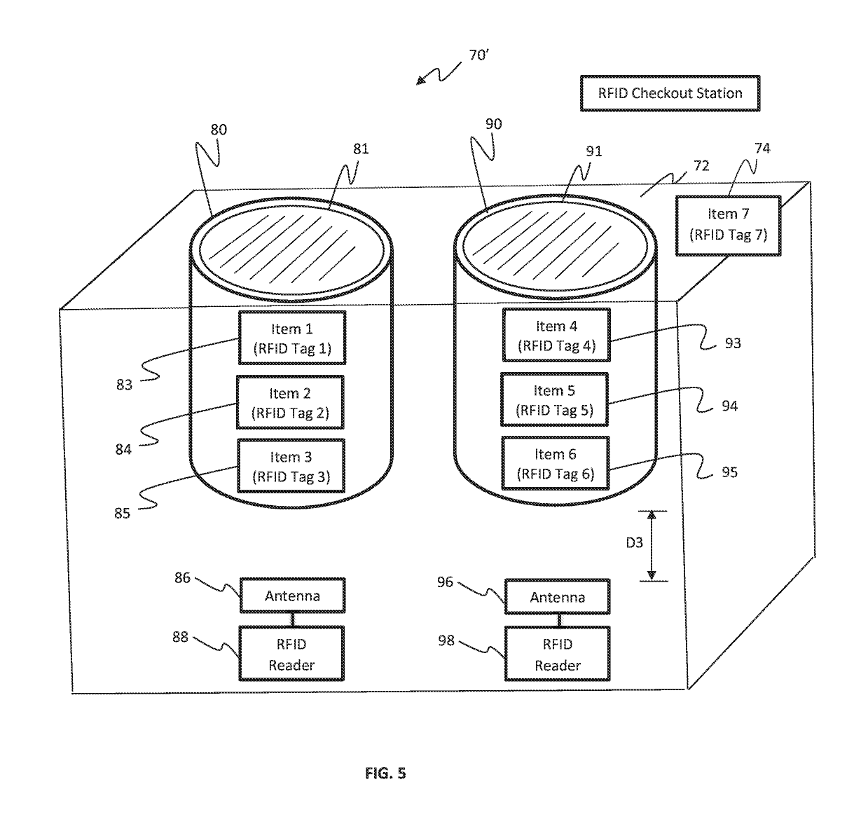

FIG. 5 is a block/flow diagram illustrating a self-service checkout station including a plurality of virtual shields defining checkout bins each having a lid, in accordance with embodiments of the present invention.

The virtual shields 80, 90 can each include a lid. For example, virtual shield 80 includes a lid 81 and virtual shield 90 includes a lid 91. The lids 81, 91 can be configured to automatically open and close. The lids 81, 91 can open and close in a horizontal direction. In one example, the lids 81, 91 can be connected to each other and move in tandem. The lids 81, 91 can be constructed from a variety of materials, such as from materials that attenuate or reflect RFID signals.

As a result, the checkout bins 80, 90 can still be designed such that they are in close proximity to each other. In one example setup, two checkout bins 80, 90 are employed, each of which is a circular (18″ by 18″) with a recess of depth 12″. The two checkout bins 80, 90 are just 22″ apart. The checkout bins 80, 90 are at a regular height of 36″ from the ground. The antennas are designed to be directional and the system uses only one antenna per checkout bin where the antenna is placed underneath the bin and it is pointing upward. A maximum power is employed to read from each antenna so that every RFID tag can be reached with a very high probability. Of course the RFID tags that are placed in the first bin can be read from both antennas, i.e., the one associated with bin 1 and the one associated with the second bin. However, the signal processing techniques described herein are used to separate and distinguish the tags that are placed in different bins.

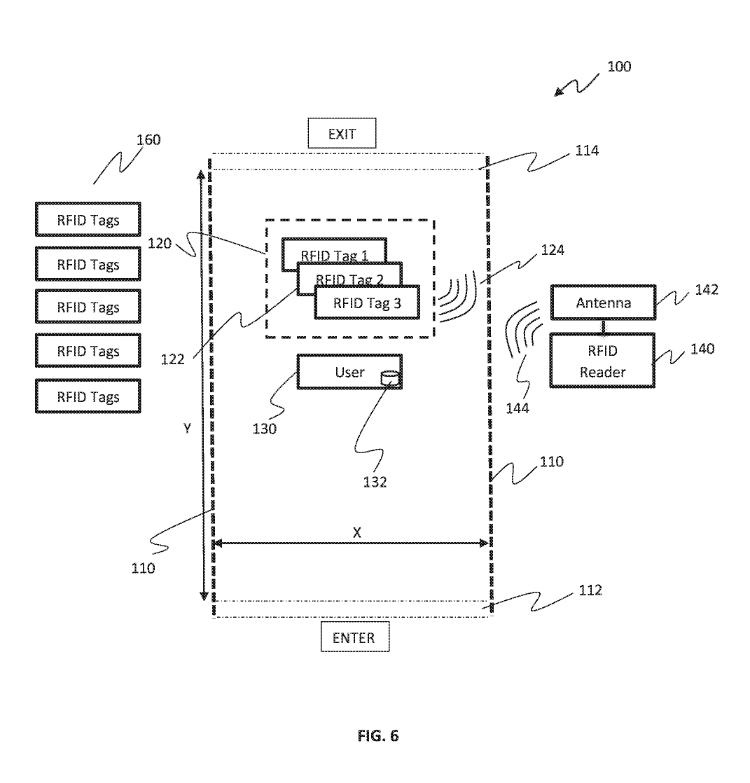

FIG. 6 is a block/flow diagram illustrating a self-service checkout station including a checkout passage, in accordance with embodiments of the present invention.

The self-checkout station 100 includes a virtual passage 110. The virtual passage 110 can be defined by dimensions “x” in the horizontal direction and “y” in the vertical direction. The virtual passage 110 can include an entry region or area 112 and an exit region or area 114. A user 130 can enter the virtual passage 110 by pushing, e.g., a shopping cart 120 that includes a plurality of items each having an RFID tag 122 attached thereto. The RFID reader 140 includes an antenna 142 for transmitting signals 144. The RFID reader 140 is positioned outside the confines of the virtual passage 110. As the user 130 walks through the virtual passage 110, the RFID tags 122 transmit a backscatter waves 124 to the RFID reader 140. The RFID reader 140 is configured to only read RFID tags 122. For example, there may be items with RFID tags 160 outside the confines of the virtual passage 110. However, the RFID reader 140 does not read the RFID tags 160.

In another exemplary embodiment, the user 130 can also include an RFID identification 132 on his/her person. Thus, it is also possible to have unique identifiers for customers for example by having an RFID enabled device or for example an RFID embedded membership card. This can facilitate the process of checkout even further by reading the items and placing then in a virtual bin of the customer that is associated with the given RFID tag. Of course, this is under the assumption that the customer has to carry the RFID enabled tag or RFID embedded card with him/her. Nonetheless, it is not even required for the customer to scan the card or even take it out of his/her wallet in the case that an RFID embedded membership card is used.

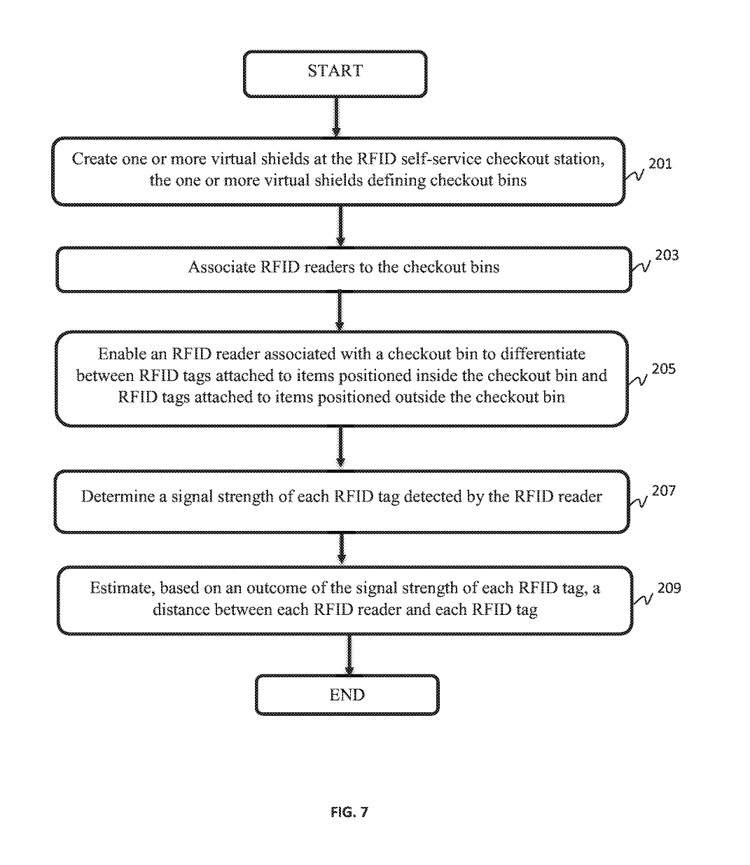

FIG. 7 is a block/flow diagram illustrating a method for detecting RFID tags attached to items positioned at a radio frequency identification (RFID) self-service checkout station, in accordance with embodiments of the present invention.

At block 201, create one or more virtual shields at the RFID self-service checkout station, the one or more virtual shields defining checkout bins.

At block 203, associate RFID readers to the checkout bins.

At block 205, enable an RFID reader associated with a checkout bin to differentiate between RFID tags attached to items positioned inside the checkout bin and RFID tags attached to items positioned outside the checkout bin.

At block 207, determine a signal strength of each RFID tag detected by the RFID reader.

At block, 209, estimate, based on an outcome of the signal strength of each RFID tag, a distance between each RFID reader and each RFID tag.

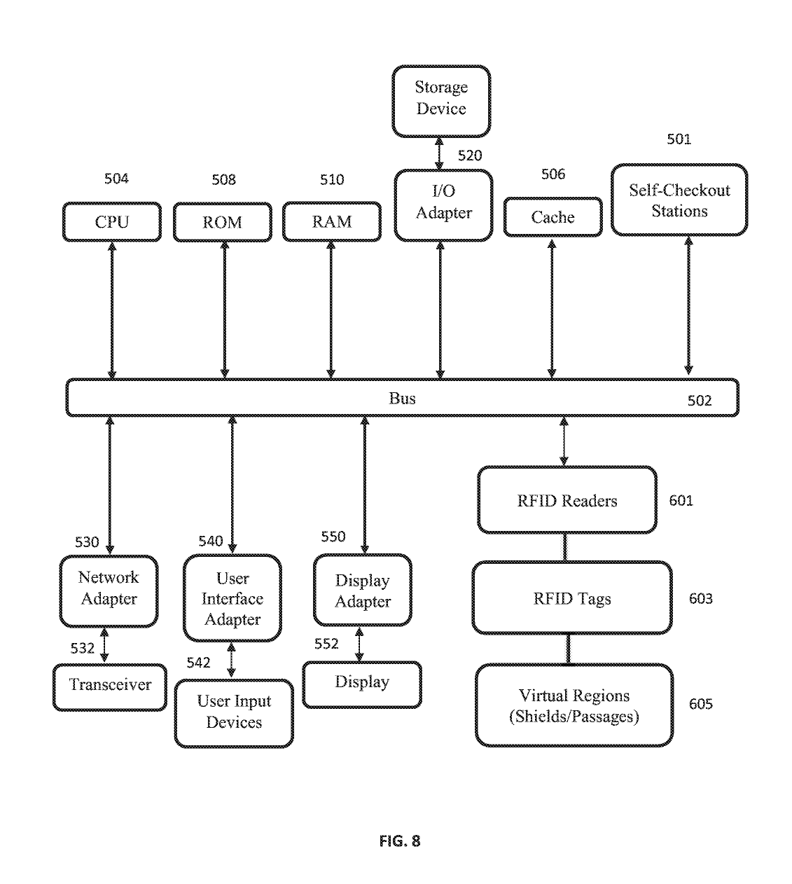

FIG. 8 is an exemplary processing system for employing a self-service checkout station including a virtual shield defining a checkout bin or a checkout passage, in accordance with embodiments of the present invention.

The processing system includes at least one processor (CPU) 504 operatively coupled to other components via a system bus 502. A cache 506, a Read Only Memory (ROM) 508, a Random Access Memory (RAM) 510, an input/output (I/O) adapter 520, a network adapter 530, a user interface adapter 540, and a display adapter 550, are operatively coupled to the system bus 502. Additionally, a self-checkout station 501 is operatively coupled to the system bus 502. The self-checkout station 501 employs RFID readers 601, RFID tags 603, and virtual regions (shields/passages) 605.

A storage device 522 is operatively coupled to system bus 502 by the I/O adapter 520. The storage device 522 can be any of a disk storage device (e.g., a magnetic or optical disk storage device), a solid state magnetic device, and so forth.

A transceiver 532 is operatively coupled to system bus 502 by network adapter 530.

User input devices 542 are operatively coupled to system bus 502 by user interface adapter 540. The user input devices 542 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 542 can be the same type of user input device or different types of user input devices. The user input devices 542 are used to input and output information to and from the processing system.

A display device 552 is operatively coupled to system bus 502 by display adapter 550.

An algorithm for executing the RFID processing can be given as follows:

Function OnTagReport( ) {
% This function runs whenever the reader has a new reading.
% This function is interrupt based
Generate a new thread to process the reading
Log wavelength, phase, RSSI, time, and EPC
Purge(current time) with respect to current time and within a time

window (interval)

% Purge is with respect to current time and within a time window
(interval)
If enough measurements run DistanceEstimation( )
}
Function DistanceEstimation( ) {
Calculate distance if enough measurement
Log UNKNOWN, VALID (IN or OUT), MOVING, and the distance
Purge(current time) with respect to current time and within a time

window (interval)

% Purge is with respect to current time and within a time window
(interval)
}
Function Purge(current time) {
Keep previous data that are within an interval from current time
Keep not more than a given number of data for each (EPC,
wavelength) pair
}
Function ClassificationTask( ) {
% It is scheduled by timer to run, say every 2 seconds
ClassifyTags( )
Display(bin content)
}
Function ClassifyTags( ) {
If no new measurement in last (interval)
The tag is expired, classify as EXPIRED
ElseIf RSSI is high enough (compare with a threshold)
Classify as IN
ElseIf RSSI is low enough (compare with a threshold)
Classify as OUT
Else
Loop on distance-estimates going back in time
log first valid estimate
count out-estimates and in-estimates
make classification UNKNOWN
If if there is at least one out-estimate and no in-estimate

classify tag as OUT

If ratio of in-estimate to out-estimate greater than a threshold, say .25

classify tag as IN

If the first valid distance is inside based on a threshold

classify tag as IN
}

}

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for detecting RFID tags attached to items positioned at a radio frequency identification (RFID) self-service checkout station, the method comprising:
creating one or more virtual shields at the RFID self-service checkout station, the one or more virtual shields defining checkout bins;
associating RFID readers to the checkout bins;
enabling an RFID reader associated with the checkout bins to differentiate between RFID tags attached to items positioned inside a checkout bin and RFID tags attached to items positioned outside the checkout bin by at least:
determining a signal strength of each RFID tag detected by the RFID reader; and
estimating, based on an outcome of the signal strength of each RFID tag, a distance between each RFID reader and each RFID tag.

2. The method of claim 1, further comprising setting the RFID readers outside an area defined by the virtual shields.

3. The method of claim 1, wherein, if the signal strength emitted from an RFID tag is above a first threshold value, then the RFID tag is determined, without performing a distance estimation, to be positioned within a checkout bin.

4. The method of claim 3, wherein, if the signal strength emitted from the RFID tag is below a second threshold value, then the RFID tag is determined, without performing the distance estimation, to be positioned outside the checkout bin.

5. The method of claim 4, wherein, if the signal strength emitted from the RFID tag is between the first and second threshold values, then the distance estimation is performed to determine whether the RFID tag is within or outside the checkout bin.

6. The method of claim 5, wherein, for the distance estimation, each RFID reader interrogates the RFID tags positioned inside its corresponding checkout bin at a plurality of frequencies and wherein, for each of the plurality of frequencies, a phase difference is measured between an RFID reader transmitted signal and a RFID tag received response.

7. The method of claim 6, wherein an average phase value for each of the plurality of frequencies is computed by removing measurement noise and ambiguity.

8. The method of claim 7, wherein the average value for each of the plurality of frequencies is used to compute a slope of a phase-frequency curve to perform the distance estimation.

9. A method for detecting RFID tags attached to items positioned at a radio frequency identification (RFID) self-service checkout station, the method comprising:
classifying the RFID tags based on their location with respect to a checkout region by at least determining a signal strength of each RFID tag and estimating a distance between each RFID tag and an RFID reader; and
estimating the distance between the RFID tag and the RFID reader by employing phase differences between signals transmitted by the RFID reader and modulated backscattered signals received from the RFID tag.

10. The method of claim 9, wherein the distance estimation identifies movement of the RFID tags or a signal reflecting object within the checkout station.

11. The method of claim 9, wherein, if the signal strength emitted from an RFID tag is above a first threshold value, then the RFID tag is determined, without performing the distance estimation, to be positioned within the checkout region.

12. The method of claim 11, wherein, if the signal strength emitted from the RFID tag is below a second threshold value, then the RFID tag is determined, without performing the distance estimation, to be positioned outside the checkout region.

13. The method of claim 12, wherein, if the signal strength emitted from the RFID tag is between the first and second threshold values, then the distance estimation is performed to determine whether the RFID tag is within or outside the checkout region.

14. The method of claim 9, wherein, for the distance estimation, the RFID reader interrogates the RFID tags determined to be positioned inside the checkout region at a plurality of frequencies.

15. The method of claim 14, wherein the phase differences are measured for each of the plurality of frequencies.

16. The method of claim 9, wherein the checkout region is a checkout bin defined by a virtual shield.

17. The method of claim 9, wherein the checkout region is a checkout passage allowing one or more users to enter and exit with the RFID tags.

18. A radio frequency identification (RFID) self-service checkout station for detecting RFID tags attached to items, the RFID self-service checkout station comprising:
one or more virtual shields defining checkout bins; and
RFID readers associated with the checkout bins, wherein an RFID reader associated with the checkout bins is configured to differentiate between RFID tags attached to items positioned inside a checkout bin and RFID tags attached to items positioned outside the checkout bin by at least determining a signal strength of each RFID tag detected by the RFID reader and estimating, based on an outcome of the signal strength of each RFID tag, a distance between each RFID reader and each RFID tag.

19. The RFID self-service checkout station of claim 18, wherein, for the distance estimation, the RFID reader interrogates the RFID tags positioned inside the checkout bin at a plurality of frequencies, the plurality of frequencies used to measure a phase difference between an RFID reader transmitted signal and a RFID tag received response.

20. The RFID self-service checkout station of claim 19, wherein an average phase value for each of the plurality of frequencies is computed by removing measurement noise and ambiguity, the average value for each of the plurality of frequencies used to compute a slope of a phase-frequency curve to perform the distance estimation.
